(19) United States
(12) Patent Application Publication
(10) Pub. No.: US 2019/0252789 A1
(43) Pub. Date: Aug. 15, 2019

(54) FREQUENCY SELECTIVE SURFACE FOR HIGH PERFORMANCE SOLAR COATINGS FOR REDUCED ENERGY CONSUMPTION IN BUILDINGS

(71) Applicant: UNIVERSITY OF IOWA RESEARCH FOUNDATION, Iowa City, IA (US)

(72) Inventors: Fatima Toor, Iowa City, IA (US); Ananda Carl Guneratne, Iowa City, IA (US); Xin Jin, Iowa City, IA (US)

(73) Assignee: UNIVERSITY OF IOWA RESEARCH FOUNDATION, Iowa City, IA (US)

(21) Appl. No.: 16/076,299

(22) PCT Filed: Feb. 7, 2017
(86) PCT No.: PCT/US2017/016858

§ 371 Date: Aug. 7, 2018

Related U.S. Application Data
(60) Provisional application No. 62/292,832, filed on Feb. 8, 2016.

(51) Int. Cl. H01Q 15/00; B32B 17/10

(52) U.S. Cl. CPC H01Q 15/0013; B32B 17/10174

(57) ABSTRACT

A solar control film having a frequency selective surface is provided. The frequency selective surface includes two layers. The first layer and the second layer which includes a metal surface. The frequency selective surface provides at least one UV absorptive material that permits substantial transmission of visible light. Products comprising the solar control film having the frequency selective surface are provided.

### RELATED APPLICATION

This application claims priority to U.S. Provisional Patent Application No. 62/292,832, filed Feb. 8, 2016, the entirety of which is incorporated herein by reference.

### FIELD

The present disclosure relates generally to methods and compositions for solar coatings having selective frequency surface properties.

### BACKGROUND

Windows have a significant impact on the energy efficiency of buildings. In the US, it is estimated that window-related solar heating of buildings is responsible for 1.48 quadrillion British thermal units (BTUs) of cooling energy consumption annually, an amount equivalent to the 0.5% of the total US energy consumption in 2011. Technologies capable of reducing this load would translate to massive energy savings. Solar control films (i.e., solar radiation control films) save energy through passive cooling of a building by reflecting or absorbing heat-generating infrared (IR) radiation.

The state-of-the-art commercially available solar control films constitute a multilayer stack consisting of a hard coat layer, an IR light-absorbing nanoparticle layer, an IR light-reflecting multilayer film, a pressure sensitive adhesive layer, and an optical substrate (FIG. 1). These multilayer solar control films are costly (˜$13/m² to $40/m²) and difficult to manufacture. The nanoparticles and IR dyes in the multilayer film are also IR-absorbing, and this absorption as a rule results in heat gain which can cause delamination, or in extreme cases glass breakage.

Frequency Selective Surfaces (FSSs) on windows reduce cooling costs by filtering out undesired wavelengths of light, reducing the amount of solar energy that enters a building. FSSs are most effective during the summer, and reject beam radiation more efficiently than diffuse light. FSSs are typically expensive, requiring multiple layers that are prone to delamination from overheating. Multilayer FSS designs often use alternating oxide layers with different refractive indices.

There are two categories of FSS; inductive FSSs, which consist of periodic holes in a conductive sheet and act as band-pass filters, and capacitive FSSs, which consist of periodic conductive antennas in a dielectric medium and act as band-stop filters. One problem inherent in many FSS designs is a tendency to block radio signals along with IR that selectively reflects target frequencies while transmitting all others.

Thus, there is a need for economical solutions for the design of solar control films that provide frequency selective surfaces for efficient UV and IR radiation reflection while permitting efficient visible light transmittance.

### BRIEF SUMMARY

In a first aspect, a solar control film having a frequency selective surface is provided. The frequency selective surface includes two layers. The first layer includes a substrate surface and the second layer includes a metal surface.

In a second aspect, a product comprising solar control film having a frequency selective surface is provided. The frequency selective surface includes two layers. The first layer includes a substrate surface and the second layer includes a metal surface.

One embodiment provides a film (e.g., a solar control film) comprising a first layer; and a second layer comprising a metal nanoparticle, the film to be frequency selective.

One embodiment provides a film (e.g., a solar control film) comprising a first layer; and a second layer comprising a metal, the film to be frequency selective.

One embodiment provides a film (e.g., a solar control film) comprising a first layer; and a second layer comprising a metal nanoparticle, the film to be frequency selective.

One embodiment provides a method comprising:

forming a second layer comprising metal nanoparticles on a surface of a first layer to provide a metal nanoparticle/first layer unit cell which comprises a frequency selective surface; and

coating one or more of the first or second layers with a third layer.

These and other features, objects and advantages of the present invention will become better understood from the description that follows. In the description, reference is made to the accompanying drawings, which form a part hereof and in which there is shown by way of illustration, not limitation, embodiments of the invention.

### BRIEF DESCRIPTION OF THE DRAWINGS

The features, objects and advantages other than those set forth above will become more readily apparent when consideration is given to the detailed description below. Such detailed description makes reference to the following drawings.

FIG. 1 depicts an exemplary prior art commercial embodiment of a multilayer solar control film 100 consisting of a hard coat layer 101, an IR light-absorbing nanoparticle layer 102, an IR light-reflecting multilayer film 103, a pressure sensitive adhesive layer 104, and an optical substrate 105.

FIG. 2 depicts an exemplary embodiment of a solar control film 200 comprising a selective frequency surface comprising a first layer 201 having a substrate surface and a second layer 202 having a metal surface.

FIG. 3A and 3B a unit cell. FIG. 3A depicts 3D and FIG. 3B depicts 2D views of a unit cell of the FSS with parameters length (L), width (W) and height (H) labeled. This unit cell is repeated in both directions with a periodicity of 400 nm.

FIGS. 4A, 4B, 4C and 4D depict exemplary scattering profiles for parametric sweeps over antenna length with W=80 nm and H=100 nm: FIG. 4A depicts the relationship between length and transmission, FIG. 4B depicts the relationship between length and reflection, FIG. 4C depicts the relationship between length and absorption, and FIG. 4D depicts the scattering profile for the selected length of 300 nm.

FIGS. 5A, 5B, 5C and 5D depict an exemplary scattering profiles for parametric sweeps over antenna width with L=300 nm and H=100 nm: FIG. 5A depicts the relationship between width and transmission, FIG. 5B depicts the relationship between width and reflection, FIG. 5C depicts the relationship between width and absorption, and FIG. 5D depicts the scattering profile for the selected width of 70 nm.

FIGS. 6A, 6B, 6C and 6D depict exemplary scattering profiles for parametric sweeps over antenna height with L=300 nm and W=70 nm: FIG. 6A depicts the relationship between height and transmission, FIG. 6B depicts the relationship between height and reflection, (c) FIG. 6C depicts the relationship between height and absorption, and FIG. 6D depicts the scattering profile for the selected height of 120 nm.

FIG. 7 depicts a comparison of reflection of a preferred embodiment of the present invention (a copper-based FSS) (squares) with the corresponding properties of commercially available multilayer co-extruded solar window coating (solid line).

FIG. 8 shows the reflection profile of the aluminum based FSS.

FIG. 9 shows the transmission profile of the aluminum based FSS.

FIG. 10 shows the absorption profile of the aluminum based FSS.

FIG. 11 shows the side view of the aluminum based FSS unit cell.

FIG. 12 shows the scanning electron microscope image of a plurality of the aluminum based FSS unit cells (repeated over the surface of the first layer).

FIG. 13 shows a process for preparing the aluminum based FSS.

FIG. 14 shows a process for preparing the aluminum based FSS wherein steps 4-8 of the process shown in FIG. 13 are replaced with nanoimprint lithography steps.

FIG. 15 shows a method for forming a nanoparticle/first layer unit cell which comprises a frequency selective surface.

While the present invention is amenable to various modifications and alternative forms, exemplary embodiments thereof are shown by way of example in the drawings and are herein described in detail. It should be understood, however, that the description of exemplary embodiments is not intended to limit the invention to the particular forms disclosed, but on the contrary, the intention is to cover all modifications, equivalents and alternatives falling within the spirit and scope of the invention as defined by the embodiments above and the claims below. Reference should therefore be made to the embodiments and claims herein for interpreting the scope of the invention.

### DETAILED DESCRIPTION

The compositions and methods now will be described more fully hereinafter with reference to the accompanying drawings, in which some, but not all permutations and variations of embodiments of the invention are shown. Indeed, the invention may be embodied in many different forms and should not be construed as limited to the embodiments set forth herein. These embodiments are provided in sufficient written detail to describe and enable one skilled in the art to make and use the invention, along with disclosure of the best mode for practicing the invention, as defined by the claims and equivalents thereof.

Likewise, many modifications and other embodiments of the compositions and methods described herein will come to mind to one of skill in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

Glossary of Terms and Definitions

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

Moreover, reference to an element by the indefinite article “a” or “an” does not exclude the possibility that more than one element is present, unless the context clearly requires that there be one and only one element. The indefinite article “a” or “an” thus usually means “at least one.”

As used herein, “about” means within a statistically meaningful range of a value or values such as a stated concentration, length, molecular weight, pH, sequence identity, time frame, temperature or volume. Such a value or range can be within an order of magnitude, typically within 20%, more typically within 10%, and even more typically within 5% of a given value or range. The allowable variation encompassed by “about” will depend upon the particular system under study, and can be readily appreciated by one of skill in the art.

Ranges recited herein include the defined boundary numerical values as well as sub-ranges encompassing any non-recited numerical values within the recited range. For example, a range from about 0.01 mM to about 10.0 mM includes both 0.01 mM and 10.0 mM. Non-recited numerical values within this exemplary recited range also contemplated include, for example, 0.05 mM, 0.10 mM, 0.20 mM, 0.51 mM, 1.0 mM, 1.75 mM, 2.5 mM 5.0 mM, 6.0 mM, 7.5 mM, 8.0 mM, 9.0 mM, and 9.9 mM, among others. Exemplary sub-ranges within this exemplary range include from about 0.01 mM to about 5.0 mM; from about 0.1 mM to about 2.5 mM; and from about 2.0 mM to about 6.0 mM, among others.

The term “UV” refers to radiation having a wavelength in the range of about 300 nm to about 450 nm. The term “IR” refers to radiation having a wavelength in the range of about 850 nm to about 1000 nm. The term “visible light” refers to radiation having a wavelength in the range of about 450 nm to about 850 nm.

Frequency Selective Surfaces

A robust solar control film comprising a frequency selective surface and compositions including the same are provided. Thus, it is to be understood that the film comprising a first layer and a second layer is frequency selective. The described frequency selective surface is made of economical materials and readily prepared using conventional lithography procedures. The frequency selective surface provides robust IR and UV reflection properties while enabling efficient transmittance of visible light. These and other aspects of the invention are described herein.

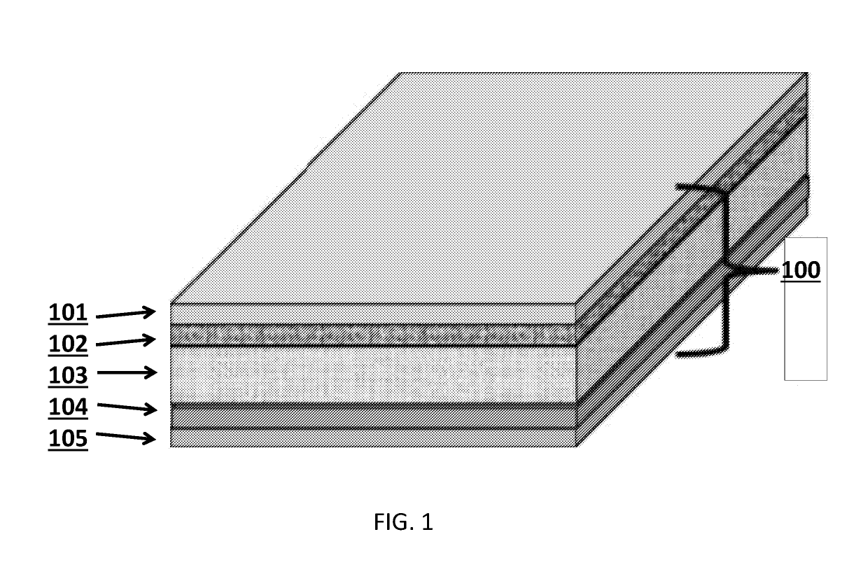

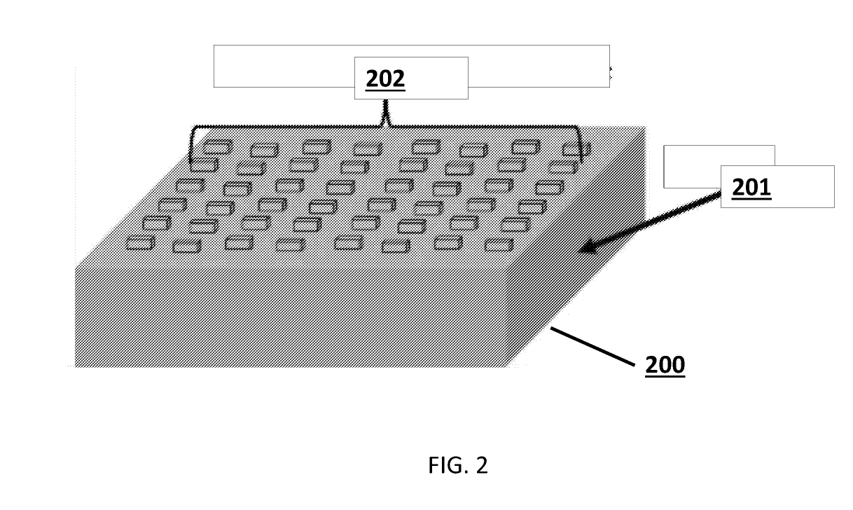

In a first aspect includes a solar control film having a frequency selective surface 200 comprising a first layer 201 having a substrate surface and a second layer 202 having a metal surface (see FIG. 1). At least one of the first layer and the second layer includes an IR reflective material. Optionally, at least one of the first layer and the second layer includes an UV reflective material. A combination of the first layer and second layer provides transmittance of visible light. Preferably, the first layer comprises an organic polymer material. Exemplary organic polymer materials include polyethylene terephthalate, polypropylene, and polystyrene, among others. Preferably, the second layer includes a metal selected from aluminum, copper, gold, silver and chromium, or a combination thereof. Most preferably, the second layer includes copper. In some respect, the second layer can be configured as a continuous metal layer, nanoparticle metal layer, or a ceramic layer including metallic materials. Preferably, the second layer includes a nanoparticulate metal material, such as a nanorod (e.g., antenna). The term nanoparticulate metal is also called a metal nanoparticle. The second layer can also be described as comprising a nano-patterned metal. The term nano-patterned metal includes a layer that comprises a defined arrangement of metal (e.g., a metal nanoparticle such as a nanorod (antenna) such as shown at FIG. 2 (202). The nano-patterned metal is usually a repeating pattern with dimensions of nanometers. The second layer can be a continuous metal layer wherein the metal of the second layer is essentially contiguous over the layer (e.g., the metal may be metal nanoparticles that essentially do not come in contact with each other but wherein there is a metal layer that is in contact with the metal nanoparticles). The second layer can also be non-continuous metal layer wherein the metal of the second layer is essentially not contiguous over the layer (e.g., the metal may be metal nanoparticles that essentially do not come in contact with each other and wherein there is not a metal layer in between the metal nanoparticles that is in contact with the metal nanoparticles).

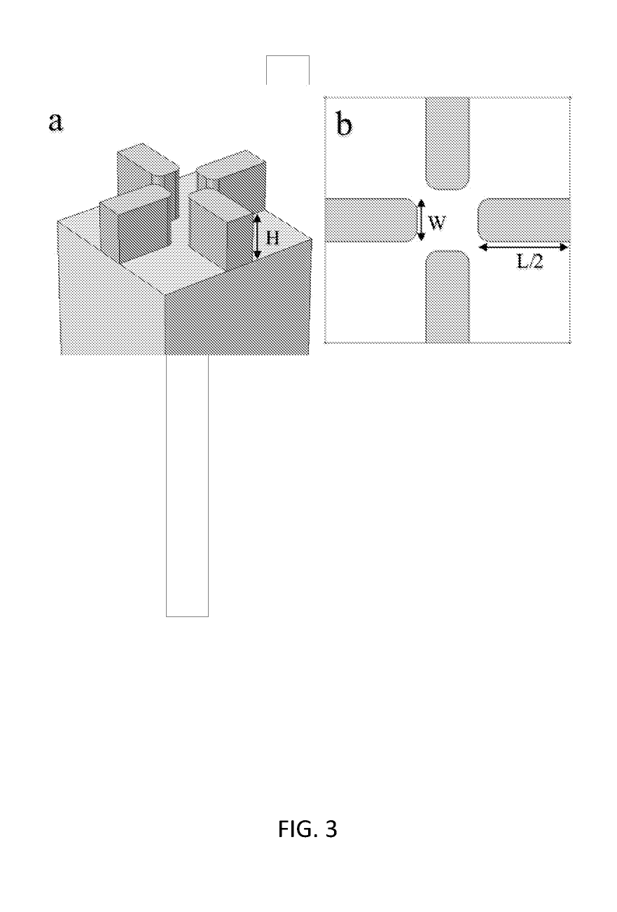

In another respect, the solar control film having the aforementioned frequency selective surface is configured as a capacitive surface comprising a plurality of unit cells having the first and second layers as described. The unit cell contains a second layer comprising at least antennas patterned on a first layer comprising substrate and aligned orthogonally with respect to each other, as seen in FIG. 3. The parameters of antenna length, width, and height are labeled as L, W, and H, wherein each of L, W and H can range from about 100 nm to about 1000 nm. The other parameter, periodicity of the domain, can be set at from about 100 nm to about 1000 nm. Preferably, unit cells have an L of about 300 nm, a W of about 70 nm, a H of about 120 nm and a periodicity domain of about 400 nm.

In some aspects, the frequency selective surface includes a second layer having an oxidative sensitive metal surface. Oxidation of such second layers can be reduced by applying a thin coating of another material to the surface to seal the surface from exposure to air. An exemplary material includes tin (Sn) for this application.

In another aspect, a product having a solar control film including a frequency selective surface is provided. The product is selected from the group consisting of UV-IR absorptive materials, including glass, fabrics and other materials. Common glass products having UV-IR absorptive properties include windows of buildings, aircraft and automobiles. Common fabrics having such properties include materials for clothing and shelters (e.g., tents).

In another aspect, nanoimprint lithography can be used to fabricate a second layer having a nanostructured frequency selective surface on a suitable substrate, such as PET. The process can include coating the metal or ceramic covered PET sheet with UV resist, stamping the pattern of the designed FSS nanostructure into the resist while exposing it to UV light, developing the resist in a chemical bath, using a dry etching process to transfer the pattern onto the metal or ceramic film, and finally removing the UV resist. Other techniques can be used to create the frequency selective surface besides nanoimprint lithography.

Protective Coating

In certain embodiments the second layer (e.g., layer comprising metal) and optionally the first layer is coated with a third layer. The third layer provides one or more properties such as chemical or mechanical protection, such as corrosion resistance, protection from oxidation or scratching. Any material to provide such properties is suitable. In one embodiment the third layer is not patterned.

Advantages Over Other Solar Control Films

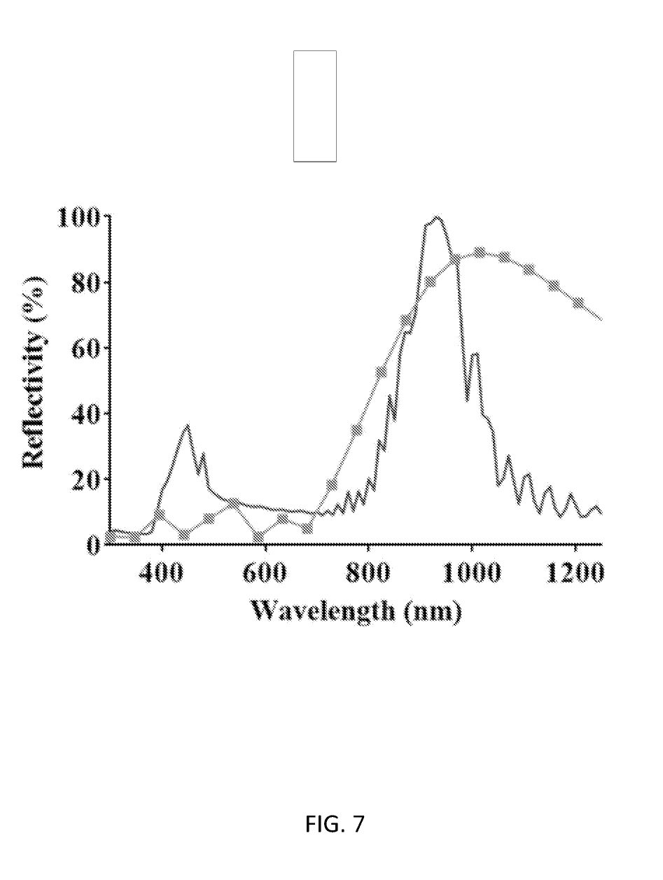

The reflection profile of designed copper-based FSS described herein with that of the commercially available multilayer co-extruded solar window coating (see FIG. 7) was examined. It is clear that even though the reflection of the commercially available film around 1000 nm wavelength is about 100%, however, it covers very narrow portion of the spectrum. The approach described herein is a significant improvement over the commercially available coating as the objective is to reflect as much IR as possible and the copper-based FSS exhibits broadband IR reflection.

### EXAMPLES

The invention will be more fully understood upon consideration of the following non-limiting examples, which are offered for purposes of illustration, not limitation.

### Example 1. Copper-Based Frequency Selective Surfaces

The design of the FSS is based on numerical analyses using various techniques. The problem setup assumes that the FSS is a planar, doubly-periodic structure with an infinite extent. These assumptions together with the uniformity of the excitation (a plane wave with a uniform amplitude) are used to simplify the analysis. The simulation domain is reduced to a single unit cell with periodic boundary conditions to account for the symmetries of the planar, periodic FSS. This approach works because all the elements of the infinite array are the same; moreover, the excitation is the same for different elements. The formulation is modified so that the effects of the periodic arrangement of the cells (symmetry) is included in the solution by application of Floquet's theorem. The unit cell contains two copper nanorods (antennas) patterned on a glass substrate and aligned orthogonally with respect to each other, as seen in FIG. 3. The parameters of antenna length, width, and height are labeled in FIG. 3 as L, W, and H. The other parameter, periodicity of the domain, is set at 400 nm.

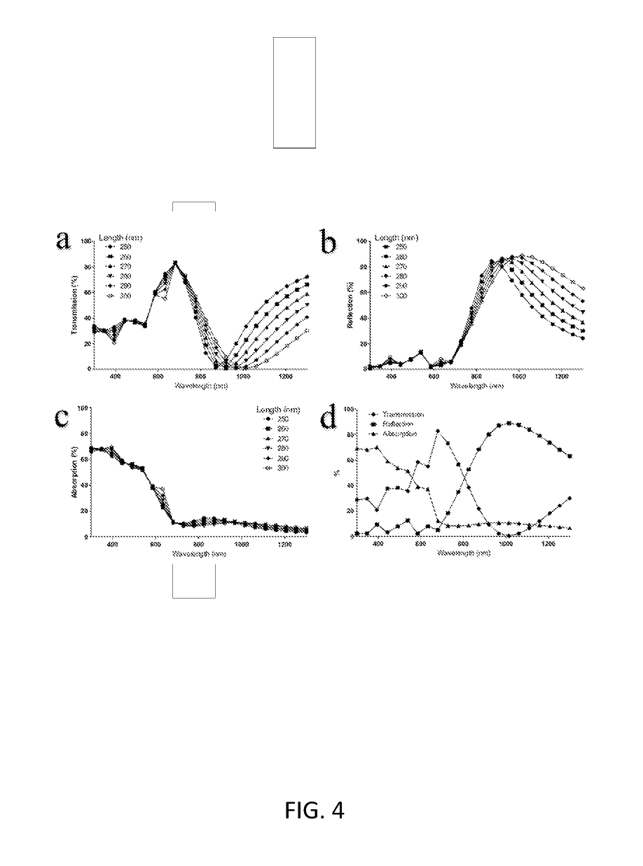

By performing parametric sweeps over the geometry of the FSS, the performance of the design was optimized and determined the effect of each parameter on the reflection profile. The relevant parameters varied are the length, width, and height of the antennas. All results were modeled using COMSOL Multiphysics. Simulations used copper optical properties derived from the Lorentz-Drude model. FIGS. 4-6 show the effect of changing geometric parameters L, W, and H on the scattering profile of the FSS. Design criteria were 1) maximizing reflection of IR wavelengths and 2) maximizing transmission of visible wavelengths.

The effect of length (L) on the design is seen in FIG. 4. Variation of length is seen to most significantly affect transmission/reflection in the IR, whereas there is very little effect on visible transmission or absorption. Increasing L results in an increase in IR reflectivity and a corresponding decrease in IR transmission. Therefore, the length parameter is best varied to maximize IR reflection. The L parameter that yields the most reflection of IR light was determined to be 300 nm.

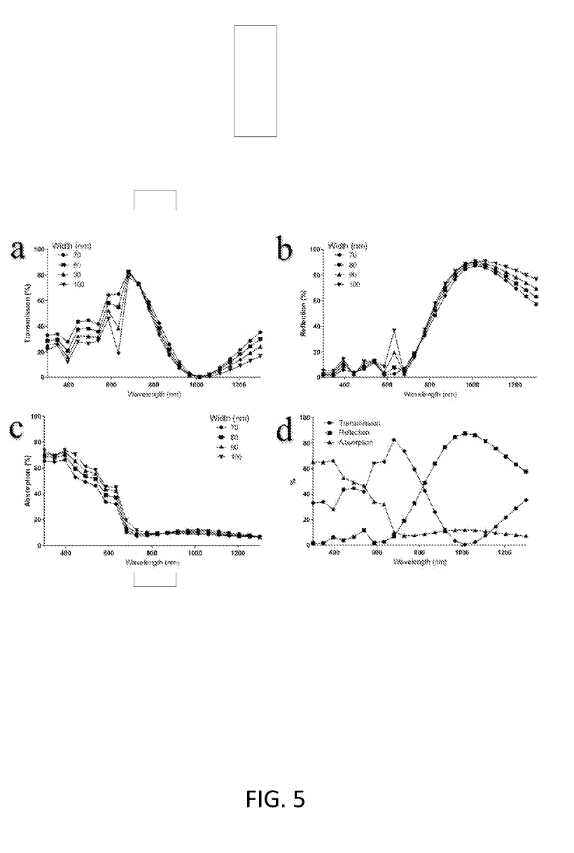

The effect of width (W) on the design is seen in FIG. 5. The width parameter is seen to most significantly affect transmission in the visible spectrum, with sharp decreases in transmission around 600 nm for greater widths. Above 1000 nm, increases to width do result in moderate gains in reflectivity with little change in absorption, but the difference does not become very large until 1200 nm, which is beyond the region of interest for reflection (700-1100 nm). Absorption in the IR is not significantly affected by the width of the antennas. Thus, this parameter is best used to maximize visible transmission by minimizing W at W=70 nm.

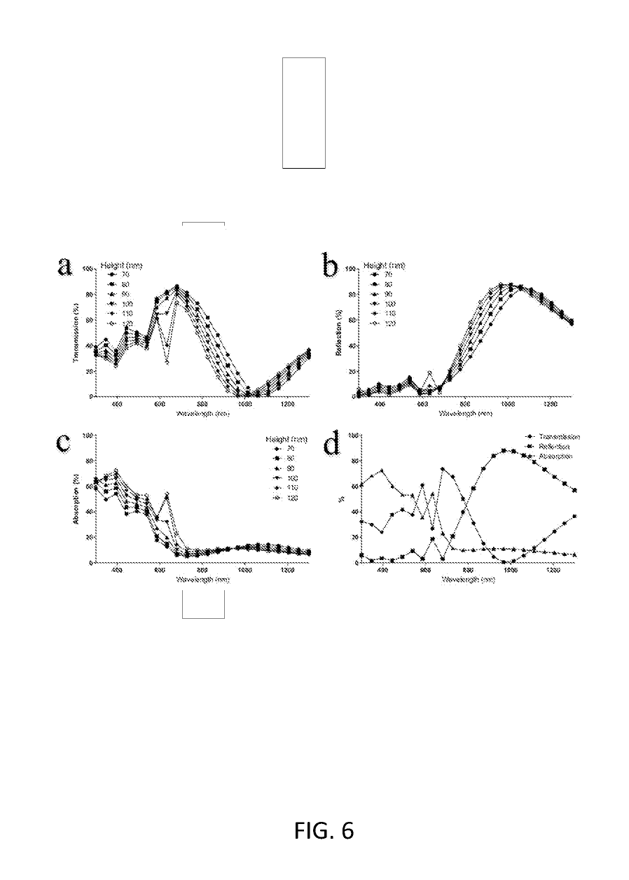

In FIG. 6, shows the effect of height (H) on the design. The height of the antennas strongly affects both IR reflection in the 800-1000 nm range and visible transmission and absorption. There is a large spike in absorption at 600 nm for H=120 nm. However, maximizing H also greatly increases IR reflection between 800 and 1000 nm. Weighing the advantages of greater IR reflectivity against the disadvantages of greater visible absorption, led to the to the maximization of reflectivity (since that is the purpose of the solar coating). Therefore, a height=120 nm was selected.

A design for the FSS with L=300, W=70, and H=120 (in nm) was chosen. As shown in FIG. 7, this design filters out most UV and IR solar radiation while still allowing visible light through. High absorption at low wavelengths prevents harmful UV radiation from passing through, while high reflection at IR wavelengths prevents warming of either the substrate or the domain behind it. In the visible range, though transmission is reduced the FSS transmits between 40% and 80% of incident light (depending on wavelength). The uneven transmission profile in the visible range will result in a tinted film biased toward the red side of the spectrum.

In practice, copper will oxidize when exposed to air. This may be prevented by placing a thin coat (˜5 nm) of tin on top of the copper antennas. This layer was modeled to determine its effects on the performance of the solar coating. To determine the optical properties of such a thin coat of tin, an e-beam evaporator was used to deposit 5 nm tin on a silicon wafer and measured the refractive index and extinction coefficient using an ellipsometer. It was found that the approximation n=2, k=0.5 could be made. A tin coating does not significantly affect IR transmission, but does decrease transmission between 600 and 800 nm while increasing transmission below 600 nm. It also causes an overall decrease of reflection across the spectrum, while increasing absorption beyond 600 nm. This increased absorption is especially noticeable between 750 and 800 nm. Below 600 nm, there is a slight decrease in absorption. In the visible regime, the tin layer has the result of smoothing distribution of solar radiation, which would decrease the tinting of the substrate. Thus, the surface with an FSS and a tin coating transmits little light in the IR and UV regimes, as desired for an FSS.

### Example 2. Aluminum-Based Frequency Selective Surfaces

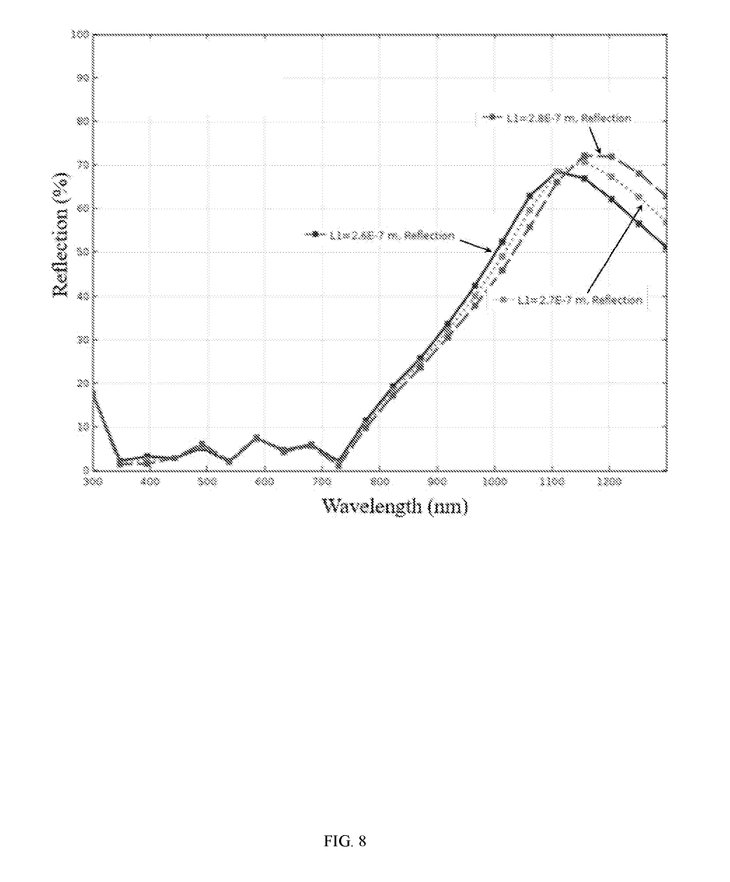

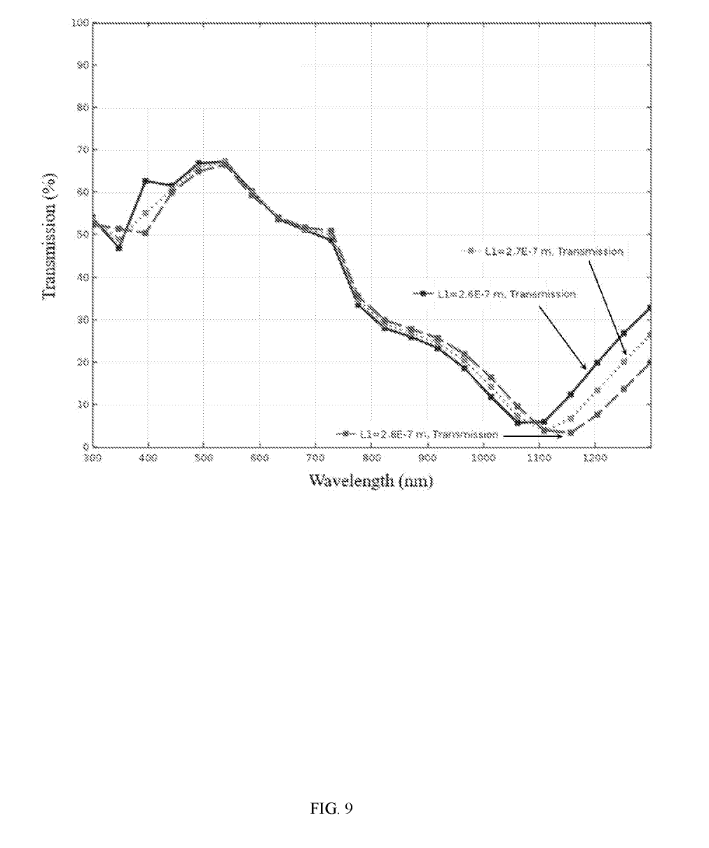

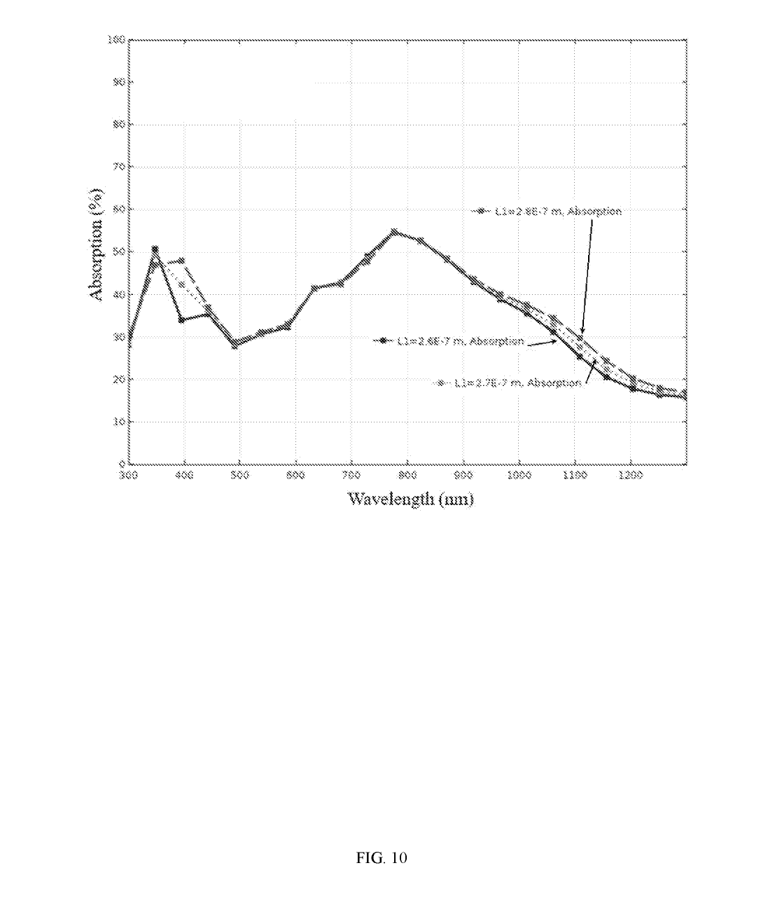

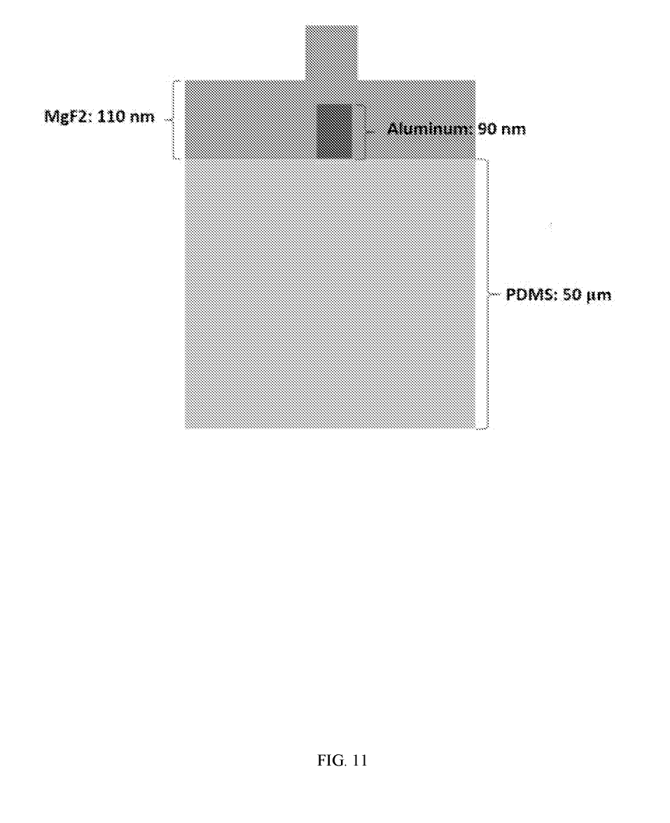

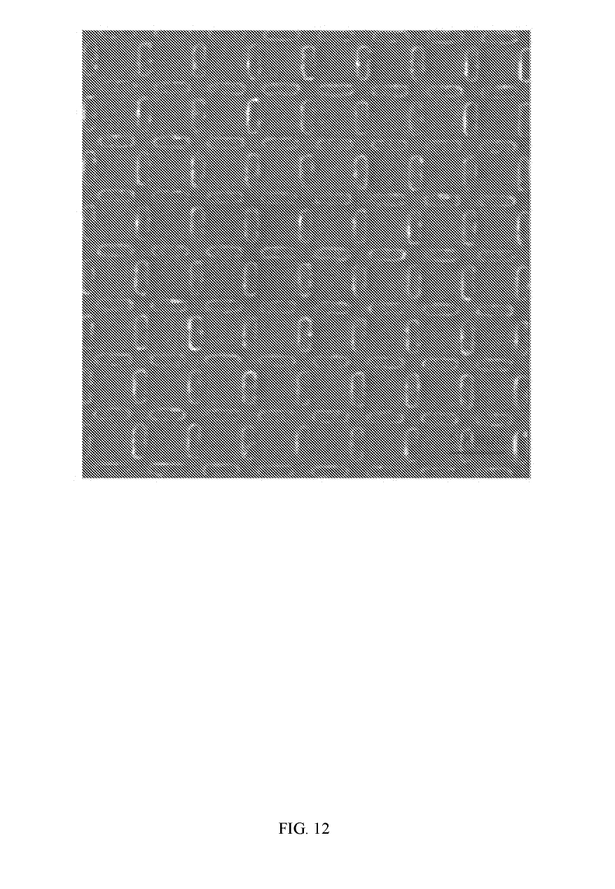

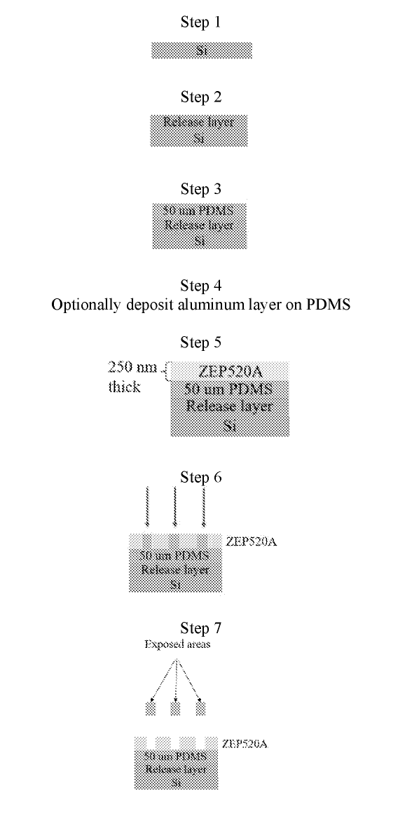

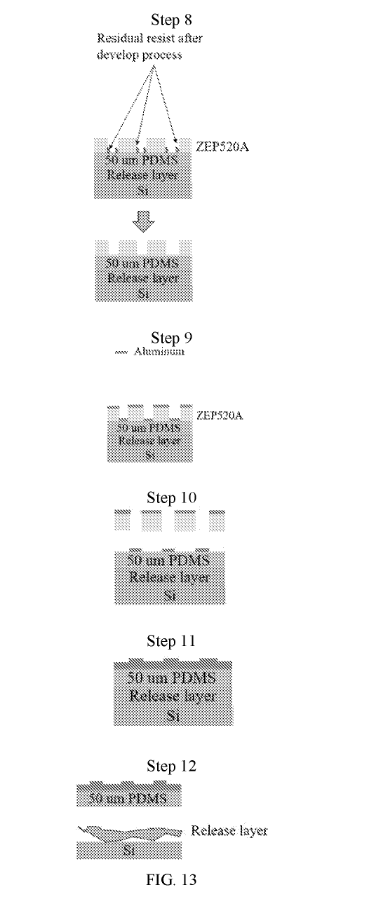

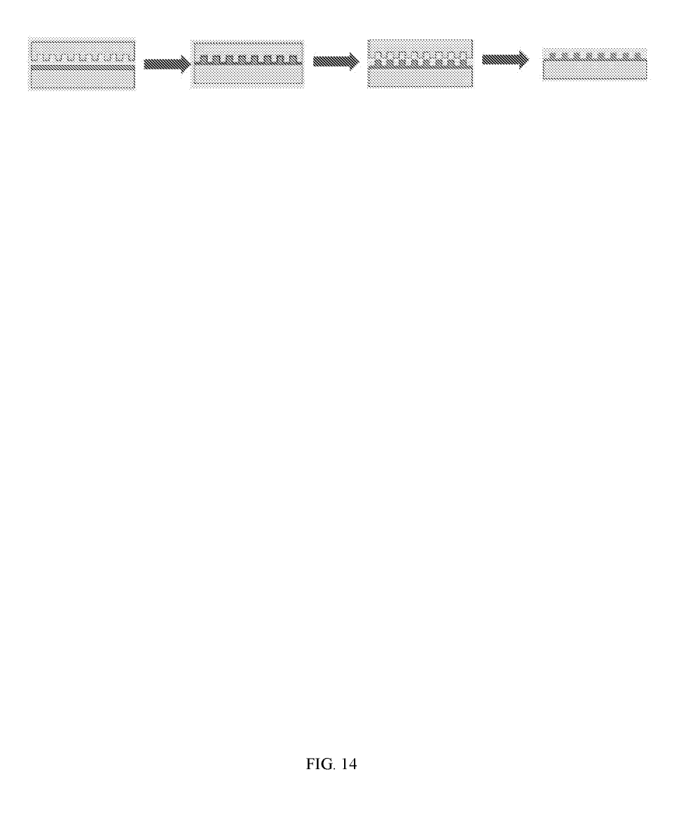

Using procedures similar to those described in example 1 an aluminum-based frequency selective surface as developed. In one embodiment the dimensions of the aluminum nano-antenna were selected wherein L=270, W=50, and H=90 (in nm). The periodicity of the domain was selected at 500 nm. FIGS. 8, 9 and 10 show the reflection, transmission and aluminum profile of the aluminum based FSS. The surface of the aluminum and exposed first layer were also coated with MgF2 using a e-beam evaporator to a thickness of about 100 nm (FIG. 11).

A method of manufacturing a film with an aluminum-based frequency selective surface was also developed. In some embodiments, a process for making a film comprising a frequency selective surface includes several steps.

First, a silicon wafer is cleaned using acetone, methanol, and isopropanol. The cleaned wafer is baked at about two-hundred degrees centigrade for about five minutes. The silicon wafer provides a substrate for the rest of the process.

Second, a release layer having a thickness of about fifteen micrometers is formed on the clean silicon wafer surface. In some embodiments, the release layer is formed by spin coating AZ4562 on the clean wafer surface. The spin coating is followed by a soft bake at about one hundred degrees centigrade for about two minutes.

Third, a first layer (e.g., a polymer such as polydimethysiloxane (PDMS)) having a thickness of about fifty micrometers is formed on the release layer. In some embodiments, the fifty micrometer layer is formed from two twenty-five micrometer layers. The first twenty-five micrometer layer (e.g., a polymer such PDMS) is formed by spin coating at about three thousand revolutions-per-minute for about sixty seconds followed by spinning at about fifteen hundred revolutions-per-minute for about one second. The first twenty-five micrometer layer is oven baked for between about ten and about fifteen minutes at about one hundred degrees centigrade. The second layer twenty-five micrometer layer (e.g., a polymer such PDMS) is formed by spin coating at about three thousand revolutions-per-minute for about sixty seconds followed by spinning at fifteen hundred revolutions-per-minute for about one second. The combined first and second twenty-five micrometer layers are then oven baked for between about ten and about fifteen minutes at about one hundred degrees centigrade.

Fourth, in some embodiments an aluminum layer having a thickness of about five nanometers is deposited on the PDMS layer.

Fifth, an e-beam resist, such as ZEP520A, is formed to a thickness of about two-hundred-and-fifty micrometers on the aluminum layer or the first layer (e.g., a polymer such PDMS) by spinning at about eight thousand revolutions-per-minute for about forty seconds. The spinning is followed by baking at about two hundred degrees centigrade for about two minutes.

Sixth, the resist is exposed substantially defining a nanostructure. In some embodiments the e-beam dose is about 190 μC/cm² to about 400 μC/cm².In one embodiment the e-beam current is about 2 nA and the accelerating voltage is about 100 kV.

Seventh, the resist is developed. In some embodiments, the development process includes amyl acetate immersion for about two minutes, isopropanol immersion for about thirty seconds, and blow drying with nitrogen. In other embodiments, xylene immersion for about forty seconds is followed by rinse in 1:3 methyl isobutyl ketone (MIBK):isopropyl alcohol (IPA) mixture for about thirty seconds, which is followed by a rinse in IPA for about thirty seconds followed by blow drying with nitrogen.

Eighth, residual resist is removed by inductively coupled plasma (ICP) etch.

Ninth, aluminum is deposited by sputtering to a thickness of about ninety nanometers at a deposition rate of about seven nanometers per minute.

Tenth, metal liftoff is affected by an acetone soak of between about five and about twenty minutes, an acetone flush of between about three and about five minutes with a squeeze bottle, an ultrasonic acetone soak of about three minutes, and an ultrasonic IPA soak of about three minutes.

Eleventh, magnesium fluoride (MgF₂) is deposited by e-beam evaporation to a thickness of about one-hundred-and-ten nanometers.

Twelfth, the release layer is dissolved by placing the silicon wafer in acetone solution and waiting for the dissolution of the AZ4362.

In some embodiments, the nanoimprint lithography process includes imprint molds that are fabricated using e-beam lithography and then these molds are utilized to fabricate nanopatterns on large areas at a high throughput and low cost. This process can be integrated with the process described above.

In one embodiment steps 4-8 are replaced with the steps described below.

The first step of the process flow for nanoimprint lithography includes the fabrication of nanoimprint molds, typically made of silicon, using e-beam lithography. These molds are then brought into contact with the sample (e.g., a first layer) coated with a thin layer of a thermoplastic and pressed together under certain pressure. When heated up above the glass transition temperature of the thermoplastic polymer, the pattern on the mold is pressed into the softened polymer film and transferred into the thermoplastic. After being cooled down, the mold is separated from the sample and the patterned thermoplastic is left on the substrate after which the Al metal deposition is performed using sputtering similar to step nine above and the rest of process steps are the same as steps ten through twelve.

The imprint molds can be used several times for patterning large areas. In the case of solar coatings the patterned area needs to be around several meters squared.

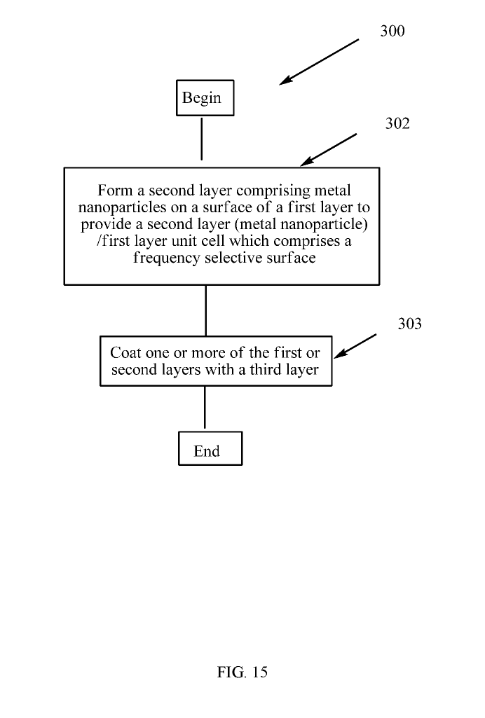

FIG. 15 shows a method 300 including forming a metal nanoparticle/first layer unit cell which comprises a frequency selective surface (block 302), and coating one or more of the first or second layers with a third layer (block 303).

In some embodiments, in the method shown in FIG. 15 the forming of the metal nanoparticle/first layer unit cell which comprises a frequency selective surface includes repeating the metal nanoparticle/first layer unit cell over the surface of the polymer.

In some embodiments, in the method shown in FIG. 15 the forming of the metal nanoparticle/first layer unit cell which comprises a frequency selective surface includes forming the metal nanoparticle/first layer unit cell using a nanoimprint mold.

In some embodiments, in the method shown in FIG. 15 the forming of the metal nanoparticle/first layer unit cell which comprises a frequency selective surface includes depositing a metal layer having a thickness of about five nanometers on the first layer.

In some embodiments, the method shown in FIG. 15 further includes forming the first layer on a release layer formed on a surface of a substrate (e.g., silicon substrate).

### EMBODIMENTS

It is to be understood that two or more embodiments provided herein below or herein above may be combined.

One embodiment provides a film comprising a first layer; and a second layer comprising a nano-patterned metal, the film to be frequency selective.

One embodiment provides a film comprising a first layer; and a second layer comprising a nano-patterned metal wherein the nano-patterned metal comprises nanoparticles, the film to be frequency selective.

One embodiment provides a film comprising a first layer; and a second layer comprising a metal nanoparticle, the film to be frequency selective.

One embodiment provides a film consisting essentially of a first layer; and a second layer comprising a metal nanoparticle, the film to be frequency selective.

One embodiment provides a film consisting of a first layer; and a second layer comprising a metal nanoparticle, the film to be frequency selective.

One embodiment provides a film comprising a first layer; and a second layer comprising a metal, the film to be frequency selective wherein the film reflects broad band radiation (e.g., broadband infrared radiation).

In one embodiment at least one of the first layer and the second layer comprises an IR reflective material.

In one embodiment at least one of the first layer and the second layer comprises an UV reflective material.

In one embodiment a combination of the first layer and the second layer provides transmittance of visible light.

In one embodiment the second layer is in contact with the first layer.

In one embodiment the first layer comprises a polymer material.

In one embodiment the first layer comprises carbon, oxygen, or silicone or mixtures thereof.

In one embodiment the first layer comprises one or more polymers selected from the group consisting of polydimethylsiloxane, polyimide, polyethylene terephthalate, polypropylene and polystyrene.

In one embodiment the first layer consists essentially of one or more polymers selected from the group consisting of polydimethylsiloxane, polyimide, polyethylene terephthalate, polypropylene and polystyrene.

In one embodiment the first layer consists of one or more polymers selected from the group consisting of polydimethylsiloxane, polyimide, polyethylene terephthalate, polypropylene and polystyrene.

In one embodiment the first layer comprises polydimethylsiloxane.

In one embodiment the first layer consists essentially of polydimethylsiloxane.

In one embodiment the first layer consists of polydimethylsiloxane.

In one embodiment the first layer is 100 nm to 1000 nm thick.

In one embodiment the first layer is 400 nm to 600 nm thick.

In one embodiment the first layer comprises glass.

In one embodiment the first layer consists essentially of glass.

In one embodiment the first layer consists of glass.

In one embodiment the first layer is capable of being flexible (e.g., being bended 5 degrees or greater, 10 degrees or greater, 20 degrees or greater, 30 degrees or greater, 40 degrees or greater, or 50 degrees or greater).

In one embodiment the first layer is essentially rigid (e.g., not being capable of being flexible such as being bended 5 degrees or greater, 10 degrees or greater, 20 degrees or greater, 30 degrees or greater, 40 degrees or greater, or 50 degrees or greater.

In one embodiment the first layer is substantially transparent to radiation.

In one embodiment the first layer is substantially transparent to visible radiation.

In one embodiment the metal nanoparticle comprises a metal selected from the group consisting of aluminum, copper, gold, silver and chromium, or a combination thereof.

In one embodiment the metal nanoparticle comprises a metal selected from the group consisting of aluminum and copper.

In one embodiment the metal nanoparticle consists essentially of a metal selected from the group consisting of aluminum and copper.

In one embodiment the metal nanoparticle consists of a metal selected from the group consisting of aluminum and copper.

In one embodiment the metal nanoparticle comprises aluminum.

In one embodiment the metal nanoparticle consists essentially of aluminum.

In one embodiment the metal nanoparticle consists of aluminum.

In one embodiment the metal nanoparticle comprises copper.

In one embodiment the metal nanoparticle consists essentially of copper.

In one embodiment the metal nanoparticle consists of copper.

In one embodiment the second layer is a continuous metal layer comprising a plurality of metal nanoparticles.

In one embodiment the second layer is not a continuous layer.

In one embodiment the second layer comprises a plurality of metal nanoparticles in the form of antennas (nanorods).

In one embodiment the second layer comprises a plurality of metal nanoparticles in the form of antennas (nanorods) patterned on the first layer wherein the antennas of the second layer are aligned substantially orthogonally with respect to the first layer.

One embodiment provides a plurality of unit cells wherein the unit cells comprise a capacitive surface.

In one embodiment the unit cell second layer comprises metal nanoparticles in the form of antennas (nanorods) patterned on the unit cell first layer wherein the antennas of the second layer are aligned substantially orthogonally with respect to the first layer.

In one embodiment the antennas have a length from about 100 nm to about 1000 nm; a width from about 20 nm to about 250 nm; a height from about 40 nm to about 400 nm.

In one embodiment the antennas have a length of 100 nm to 1000 nm; a width of 20 nm to 250 nm; a height of 40 nm to 400 nm.

In one embodiment the antennas have a periodicity domain from about 100 nm to about 600 nm.

In one embodiment the antennas have a periodicity domain from about 300 nm to about 550 nm.

In one embodiment the antennas have a periodicity domain from about 350 nm to about 550 nm.

In one embodiment the antennas have a periodicity domain from about 350 nm to about 450 nm.

In one embodiment the antennas have a periodicity domain from about 380 nm to about 420 nm.

In one embodiment the antennas have a periodicity domain of about 400 nm.

In one embodiment the antennas have a periodicity domain from about 450 nm to about 550 nm.

In one embodiment the antennas have a periodicity domain from about 480 nm to about 520 nm.

In one embodiment the antennas have a periodicity domain of about 500 nm.

In one embodiment the antennas have a periodicity domain of 100 nm to 1000 nm.

In one embodiment the antennas have a length from 100 nm to 1000 nm; a width from 20 nm to 250 nm; a height from 40 nm to 400 nm and a periodicity domain from 100 nm to 1000 nm.

In one embodiment the second layer comprises copper wherein the antennas have a length from about 270 nm to about 330 nm, a width from about 60 nm to about 80 nm, a height from about 105 nm to about 135 nm and a periodicity domain from about 360 nm to about 440 nm.

In one embodiment the second layer comprises copper wherein the antennas have a length from 270 nm to 330 nm, a width from 60 nm to 80 nm, a height from 105 nm to 135 nm and a periodicity domain from 360 nm to 440 nm.

In one embodiment the second layer comprises copper wherein the antennas have a length from about 220 nm to about 330 nm, a width from about 40 nm to about 100 nm, a height from about 90 nm to about 150 nm and a periodicity domain from about 320 nm to about 500 nm.

In one embodiment the second layer comprises copper wherein the antennas have a length from about 290 nm to about 310 nm, a width from about 65 nm to about 75 nm, a height from about 115 nm to about 125 nm and a periodicity domain from about 380 nm to about 420 nm.

In one embodiment the second layer comprises copper wherein the antennas have a length from about 295 nm to about 305 nm, a width from about 68 nm to about 72 nm, a height from about 118 nm to about 122 nm and a periodicity domain from about 395 nm to about 405 nm.

In one embodiment the second layer comprises copper wherein the antennas have a length of about 300 nm, a width of about 70 nm, a height of about 120 nm and a periodicity domain of about 400 nm.

In one embodiment the second layer comprises aluminum wherein the antennas have a length from about 240 nm to about 300 nm, a width from about 45 nm to about 55 nm, a height from about 80 nm to about 100 nm and a periodicity domain from about 450 nm to about 550 nm.

In one embodiment the second layer comprises aluminum wherein the antennas have a length from 240 nm to 300 nm, a width from 45 nm to 55 nm, a height from 80 nm to 100 nm and a periodicity domain from 450 nm to 550 nm.

In one embodiment the second layer comprises aluminum wherein the antennas have a length from about 210 nm to about 330 nm, a width from about 30 nm to about 70 nm, a height from about 60 nm to about 120 nm and a periodicity domain from about 420 nm to about 580

In one embodiment the second layer comprises aluminum wherein the antennas have a length from about 260 nm to about 280 nm, a width from about 47 nm to about 53 nm, a height from about 85 nm to about 95 nm and a periodicity domain from about 480 nm to about 520 nm.

In one embodiment the second layer comprises aluminum wherein the antennas have a length from about 265 nm to about 275 nm, a width from about 48 nm to about 52 nm, a height from about 87 nm to about 93 nm and a periodicity domain from about 495 nm to about 505 nm.

In one embodiment the second layer comprises aluminum wherein the antennas have a length of about 270 nm, a width of about 50 nm, a height of about 90 nm and a periodicity domain of about 500 nm.

In one embodiment the film comprises a first and second layer that further comprises a third layer.

In one embodiment the film consists essentially of a first and second layer that further consists essentially of a third layer.

In one embodiment the film consists of a first and second layer that further consists of a third layer.

In one embodiment the third layer is in contact with the second layer.

In one embodiment the third layer is in contact with the first and second layers.

In one embodiment the third layer is in contact with the surface of the 3 second layer.

In one embodiment the third layer is in contact with the surface of the first and second layers.

In one embodiment the third layer comprises tin or magnesium.

In one embodiment the third layer consists essentially of tin or magnesium.

In one embodiment the third layer consists of tin or magnesium.

In one embodiment the third layer comprises a dielectric material.

In one embodiment the third layer is about 2 nm to about 200 nm thick

In one embodiment the third layer is about 2 nm to about 150 nm thick

In one embodiment the third layer is about 2 nm to about 120 nm thick

In one embodiment the third layer is about 1 nm to about 140 nm thick

In one embodiment the third layer comprises tin and wherein the third layer is about 2 nm to about 10 nm thick

In one embodiment the third layer comprises magnesium, wherein the third layer is about 100 nm to about 120 nm thick.

In one embodiment the third layer comprises MgF₂.

In one embodiment the third layer comprises magnesium in the form of a magnesium compound (e.g., magnesium metal (not in compound form (e.g., essentially pure) is excluded).

In one embodiment the third layer comprises a magnesium compound (e.g., MgF₂).

In one embodiment the any comprising term may be independently consisting essentially of or consisting of.

In one embodiment the frequency selective film reflects greater than about 20%, greater than about 30%, greater than about 40%, greater than about 50%, greater than about 60%, greater than about 70%, greater than about 80%, or greater than about 90% infrared radiation. In one embodiment the infrared radiation is from a range of about 850 nm to about 1000 nm, about 850 to about 4000 nm, about 850 to about 2000 nm, about 850 to about 1500 nm, or about 850 to about 1050 nm. It is to be understood that any of the embodiments specifying percentage reflection of infrared radiation can be combined independently with any of the embodiments specifying the infrared radiation range.

In one embodiment the frequency selective film reflects broad band radiation (e.g., broadband infrared radiation such as peak in the infrared radiation region (e.g., 850 nm-4000 nm) that has a full width half maximum of the reflection peak of greater than about 200 nm, greater than about 250 nm, greater than about 300 nm, greater than about 400 nm, greater than about 500 nm, greater than about 700 nm, greater than about 900 nm, or greater than about 1000 nm.

In one embodiment the frequency selective film has a reflection peak in the infrared radiation region (e.g., a range of about 850 nm to about 1000 nm, about 850 to about 4000 nm, about 850 nm to about 2000 nm, about 850 nm to about 1500 nm, or about 850 nm to about 1050 nm) wherein the full width half maximum of the reflection peak is greater than about 200 nm, greater than about 250 nm, greater than about 300 nm, greater than about 400 nm, greater than about 500 nm, greater than about 700 nm, greater than about 900 nm, or greater than about 1000 nm. It is to be understood that any of the embodiments specifying the infrared radiation range can be combined independently with any of the embodiments specifying reflection peak full width half maximum.

One embodiment provides a product comprising a film as described herein.

One embodiment provides a product comprising a film as described herein, which comprises a glass material or a fabric material.

One embodiment provides a product comprising a film as described herein, wherein the product comprises a UV-IR absorptive material.

One embodiment provides a product comprising a film as described herein, wherein the UV-IR absorptive material comprises a glass material or a fabric material.

### INCORPORATION BY REFERENCE

All of the patents, patent applications, patent application publications and other publications recited herein are hereby incorporated by reference as if set forth in their entirety.

In particular, the present disclosure includes three appendices that are filed as part of this application, wherein the contents of these appendices are hereby incorporated by reference.

The present invention has been described in connection with what are presently considered to be the most practical and preferred embodiments. However, the invention has been presented by way of illustration and is not intended to be limited to the disclosed embodiments. Accordingly, one of skill in the art will realize that the invention is intended to encompass all modifications and alternative arrangements within the spirit and scope of the invention as set forth in the appended claims.

1. A frequency selective film comprising:
a first layer; and
a second layer comprising a plurality of metal nanoparticles in the form of antennas (nanorods) wherein the antennas have a length from about 100 nm to about 1000 nm; a width from about 20 nm to about 250 nm; and a height from about 40 nm to about 400 nm.
the film to be frequency selective.

2. The film of claim 1, wherein at least one of the first layer and the second layer comprises an IR reflective material.

3. The film of claim 1, wherein at least one of the first layer and the second layer comprises an UV reflective material.

4. The film of claim 1, wherein a combination of the first layer and the second layer provides transmittance of visible light.

5. The film of claim 1, wherein the second layer is in contact with the first layer.

6. The film claim 1, wherein the first layer comprises a polymer material.

7-8. (canceled)

9. The film of claim 1, wherein the first layer is 400 nm to 600 nm thick.

10. The film of claim 1, wherein the first layer comprises glass.

11. The film claim 1, wherein the metal nanoparticle comprises a metal selected from the group consisting of aluminum, copper, gold, silver and chromium, or a combination thereof.

12-16. (canceled)

17. The film of claim 1, wherein the second layer comprises a plurality of metal nanoparticles in the form of antennas (nanorods) patterned on the first layer wherein the antennas of the second layer are aligned substantially orthogonally with respect to the first layer.

18-21. (canceled)

22. The film of claim 1, wherein the antennas have a periodicity domain from about 100 nm to about 1000 nm.

23-24. (canceled)

25. The film of claim 1, wherein the second layer comprises copper wherein the antennas have a length from about 270 nm to about 330 nm, a width from about 60 nm to about 80 nm, a height from about 105 nm to about 135 nm and a periodicity domain from about 360 nm to about 440 nm.

26. The film of claim 1, wherein the second layer comprises aluminum wherein the antennas have a length from about 240 nm to about 300 nm, a width from about 45 nm to about 55 nm, a height from about 80 nm to about 100 nm and a periodicity domain from about 450 nm to about 550 nm.

27. The film of claim 1 further comprising a third layer.

28-29. (canceled)

30. The film of claim 27, wherein the third layer comprises tin or magnesium.

31-33. (canceled)

34. A product comprising a solar radiation control film as described in claim 1.

35. The product of claim 34, which comprises a glass material or a fabric material.

36-37. (canceled)

38. A method comprising:
forming a second layer comprising metal nanoparticles on a surface of a first layer to provide a metal nanoparticle/first layer unit cell which comprises a frequency selective surface; and
coating one or more of the first or second layers with a third layer,
wherein the metal nanoparticles are in the form of antennas (nanorods) patterned on the first layer wherein the antennas of the second layer are aligned substantially orthogonally with respect to the first layer and wherein the antennas have a length from about 100 nm to about 1000 nm; a width from about 20 nm to about 250 nm; and a height from about 40 nm to about 400 nm.

39-40. (canceled)

41. The method of claim 38, wherein the antennas have a periodicity from about 100 nm to about 1000 nm.

42-47. (canceled)

48. The film of claim 1 in contact with a window.
